(19) United States
(12) Patent Application Publication
(10) Pub. No.: US 2008/0093753 A1
(43) Pub. Date: Apr. 24, 2008

(54) PROCESS FOR THERMO-MOLDING CONVEX MIRRORS

(76) Inventor: Mark SCHUETZ, Mt. Vernon, OH (US)

Correspondence Address: OSTROLENK FABER GERB & SOFFEN, 1180 AVENUE OF THE AMERICAS, NEW YORK, NY, 100368403, US

(21) Appl. No.: 11/875,507

(22) Filed: Oct. 19, 2007

Related U.S. Application Data
(60) Provisional application No. 60/862,092, filed on Oct. 19, 2006.

(51) Int. Cl. B29D 11/00; B29C 44/00

(52) U.S. Cl. 264/1.9; 264/45.1

(57) ABSTRACT

A low cost process of particular utility in manufacturing optical grade objects such as mirrors from a plastic sheet, comprising the steps of selecting a predefined three dimensional shape to be formed and machining a block of a microporous material, to provide the selected three dimensional shape on one surface thereof. A sheet of plastic is placed over the machined three dimensional shape and distanced therefrom. The sheet of plastic is heated a vacuum is applied through the microporous material to draw the heated plastic sheet to conform to the shape in the block. A surface of the conformed shape plastic is metallized to a form an optical mirror surface.

### CROSS-REFERENCE TO RELATED APPLICATION

This application is based on and claims priority to U.S. Provisional Patent Application Ser. No. 60/862,092, filed on Oct. 19, 2006 and entitled PROCESS FOR THERMO-MOLDING CONVEX MIRRORS, the entire contents of which are hereby incorporated by reference herein.

### BACKGROUND OF THE INVENTION

The present invention relates to the molding of non-planar optical grade mirrors from plastic stock and particularly to the production of convex mirrors.

It is the current practice to utilize injection molding processes to form plastic parts which are metallized to provide mirrors such as convex mirrors used in various optical applications. However, such processes are generally high cost especially with the need for production mold tools and suffer from incomplete adhesion between the plastic of the parts and the metallization, and dimensional distortion and blemishes in the final product.

### SUMMARY OF THE INVENTION

It is an object of the present invention to provide a low cost alternative process to injection molding which also provides dimensionally more accurate parts. It is also an object of the process to permit the production of fewer parts at a reasonable cost per part without the initial huge start-up cost of creating an injection molding tool.

It is a further object of the present invention to provide a process of thermo molding of mirror parts with less or minimal distortion and blemishes and better adhesion between the plastic and the metallization to provide a higher quality product with better durability in the field.

Other features and advantages of the present invention will become apparent from the following description of the invention which refers to the accompanying drawings.

### BRIEF DESCRIPTION OF THE DRAWINGS

FIG. 1 schematically depicts an exploded view of the production of a convex mirror in accordance with the invention; and

FIGS. 2a and 2b depict the formed mirror product as produced and processed for use respectively.

### DETAILED DESCRIPTION OF EMBODIMENTS OF THE INVENTION

Generally the present invention comprises a manufacturing process for producing arbitrary pre-determined three-dimensional shapes from plastic sheets, while preserving the integrity of the sheets. The finished products can have optical integrity which makes them suitable for mirrors, reflectors, signs, camera domes, and other optically sensitive applications. The shapes may be pre-selected by using three dimensional CAD software, and they can be manufactured using this process. Furthermore, since the process is based on thermally molding parts starting from an initially flat sheet, the tooling is much lower cost than would be the case if a person tried to injection mold a similar part. The overall steps in this process generally include:

1. Construction/design of molding tooling.

2. Selection of raw materials for the plastic stock

3. Heating, shaping, and cooling the part

Finishing the Part

More specifically the process of forming an optically accurate non-planar element from a plastic sheet, comprises the steps of:

4. selecting a predefined three dimensional shape to be formed;

5. machining a block of a microporous material, such as by entering the selected shape into CAD/CAM or similar software and using the software to drive a machining tool to machine the block, to provide the selected three dimensional shape on one surface thereof;

6. placing a sheet of plastic over the machined three dimensional shape and distanced therefrom;

7. heating the sheet of plastic and applying a vacuum through the microporous material to draw the heated plastic sheet to conform to the shape in the block; and for optical parts such as a mirror;

8. metallizing a surface of the conformed shape plastic to a form an optical mirror surface.

Tooling Construction and Design:

The molding tool used in the process of the present invention comprises a machined block of a microporous material, preferably aluminum, such as MetaPor, a microporous solid aluminum material supplied by the Edward D. Segen & Company. Other microporous materials made from other metals or non-metals such as ceramics may also be used, but microporous aluminum is preferred for its advantages of high thermal conductivity and its property of being polishable to a very smooth surface finish. The tool is machined (preferably by using three-dimensional CAD/CAM software or any suitable machining method) to produce any three dimensional shape desired, with the exception of undercuts. After machining, the block is preferably polished to a high polish using progressively finer and finer grit sand paper, or by using progressively finer abrasive non-wovens.

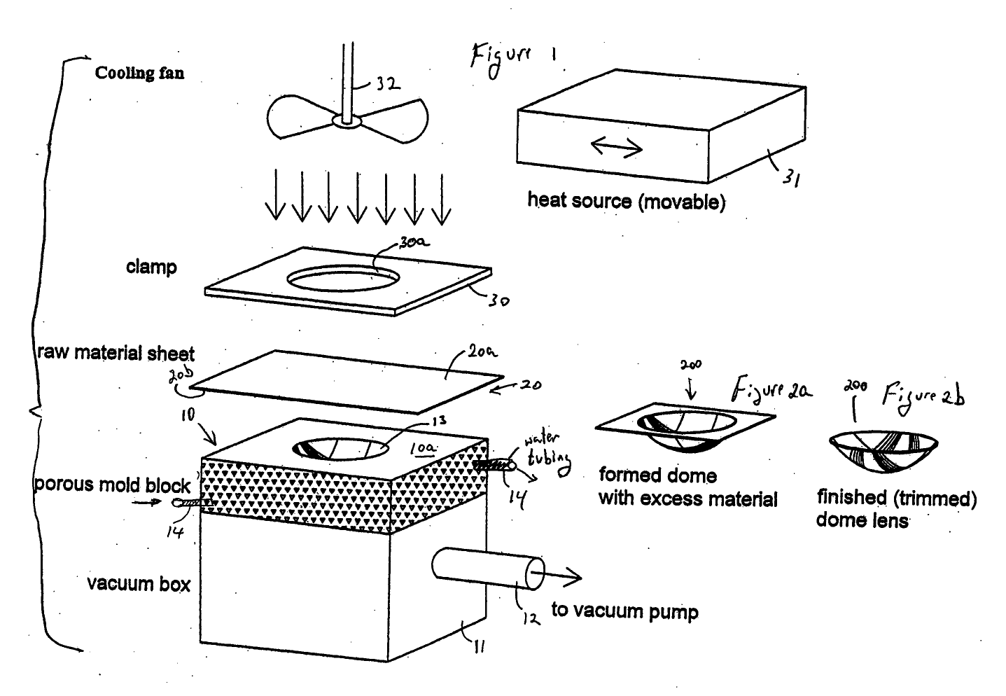

In a preferred embodiment, the block is fitted with elements for precise uniform temperature control such as copper water tubes (element 14 in FIG. 1) through which water of selected temperature is run. For the production of a second surface convex mirror, a female tool produced in the block, is preferred. Though a male tool can be used and is included in the present invention a female tool is preferred to provide better visual quality in a second surface convex mirror. Similarly, for a second surface concave mirror, a male tool is preferred with a female tool being able to be used but with a male tool providing a better visual quality in a second surface concave mirror. The opposite would be the case for first surface mirrors. In all cases the tool is preferably constructed so that the metallization (applied later to make the mirror reflective) is applied to the surface that does not come into contact with the mold. Such construction is preferred since there may be some very slight tool mark-off, and advantageously this occurs on the surface opposite the metallization. A shown in FIG. 1, the block 10 is fitted to a vacuum box 11 so that air may be extracted through the porous block to a vacuum pump (not shown) via conduit 12, sucking the heated plastic sheet 20 against the block 10, causing it to conform dimensionally very precisely to the block 10 and the machined shape 13. Apertured clamp 30 holds the sheet in place against the surface 10a of block 10 and initially distanced from the machined shape 13. Movable heat source 31 such as an infra red heater is used to heat the plastic sheet 20 through aperture 30a. Cooling fan 32 is actuated when and as needed to cool the plastic sheet 20 through aperture 30a.

Raw Materials:

Optical quality sheet stock is used to achieve a finished part with optical quality sufficient for a mirror, preferably in thicknesses from 1 mm to 6 mm. Both Plaskolite and Degussa make such “mirror grade” sheet at this time from extruded acrylic, although the invention is not limited to materials from these two vendors, and is not limited to this thickness range. Mirror quality parts thermo-molded may also be made with polycarbonate sheet, with PETG sheet and other similar materials. It is understood that the present process will not eliminate original defects put there by the original sheet manufacturing process, and it is preferred to initially start with a high quality.

There is a preference for the sheets to initially have poly masking (2-3 mil thick) on both sides (with no residue leaving adhesives) during heating. The poly mask also protects the surface integrity of the sheet during shipping and handling. Furthermore, during the forming process the poly mask on the side of the sheet is left to contact the mold if possible. With acrylics, this works extremely well, and any tiny mold mark-off is absorbed in the poly mask. When the poly mask is eventually stripped off and disposed of, the mold mark-off disappears with it leaving a pristine mirror surface. With polycarbonate this is not as preferred if the required forming temperature might be too high for the poly mask. Accordingly, with higher temperature heated materials such as polycarbonate, the masking is preferably stripped from both sides of the sheet prior to forming.

Heating, Shaping, Cooling the Part:

As shown in FIG. 1, the sheet 20 is clamped in a frame above the mold 13 and heat is applied from one side only. Preferably heat is applied via infrared heaters for typically 20-180 seconds (thinner sheet heats quicker, thicker sheet heats slower) to the side of the sheet 20a that is not going to be in contact with the mold. This permits the side 20b to be in contact with the mold to be a bit cooler than the other side. Nonetheless any heating method whatsoever may be used to similar effect. Infrared heating from one side is preferable due to the desirable temperature gradient described above. So while the sheet is hot enough to be formed to the desired three dimensional shape, one side is a bit cooler and this minimizes tooling mark-off. The temperature of the plastic will affect the results. Longer exposure to the infrared heaters will give the best dimensional accuracy, but will increase mold mark-off.

After heating, the part is shaped by pulling vacuum through the porous metal, sucking the part against the mold for final dimensions as well as for cooling. As opposed to a porous structure or one with a minimal number of holes, microporous materials have millions of tiny vacuum holes, with the amount of air being extracted being roughly equal over the entire surface of the mold. Thus, conventional thermoforming molds made with solid aluminum are commonly fabricated by drilling numerous little holes (typically smaller than 1.5 mm and typically larger than 0.1 mm) in solid aluminum molds. Drilled vacuum holes however produce small optical defects at the location of the drilled hole. These defects may be due to the air movement in the vicinity of the vacuum hole in addition to the fact that the plastic must literally bridge the hole. In mirrors and other optically sensitive parts, this produces unsightly defects in the finished product. The porous metal tool used in thermo-molding of the present invention produces no such defects since there are literally millions of microscopic holes (with each having, on average, a diameter smaller than 0.02 mm) over the entire surface of the mold.

With respect to temperature control of the mold (formed shape 13), the mold should be hot enough to permit the part to accurately conform to the mold dimensionally, but not too hot. With acrylics, the best results are obtained with a mold temperature greater than 120° F. but lower than 200° F. The mold temperature is controlled by passing controlled temperature water through the mold's water tubes (element 14 in FIG. 1). Microporous aluminum is preferable in this aspect since the high thermal conductivity and high thermal mass will cause the mold temperature to be extremely uniform over the entire mold surface. As a result, when the hot plastic sheet contacts the mold, it will begin cooling from such contact, but not at an excessive rate, and the cooling effect will be uniform over the entire part. This produces the same dimensional accuracy and the same high optical quality over the entire part. In addition, once the vacuum process is started and in order as to effectively shape the part, it is preferred that the heat source be removed and (optionally) fan 32 blow room temperature air across the back side, thereby providing uniform cooling from both sides of the part. Plastic shrinks quite a lot when it cools from forming temperature to room temperature, and if not for the vacuum holding the part and for the poly film mask, when the part shrinks it would create thousands of tiny scratches and blemishes in the surface of the part. However, no such blemishes occur in thermo-molding of the present invention because the vacuum holds the part securely against the mold during cooling and because the poly mask absorbs any tiny mark off and does not transmit those defects on to the finished part surface and it is highly preferred that the vacuum be maintained until the part has sufficiently cooled. The end result is that when the part 200 in FIGS. 2a and 2b is cooled back to room temperature and the poly mask is stripped off, the part has a pristine surface suitable for mirrors or other optically sensitive applications.

Finishing the Part:

After demolding, if manufacturing a mirror, the part is vacuum metallized to become reflective with the adhesion between the deposited metal and the plastic being excellent. This results from the surface being metallized being protected with a poly mask until just prior to thermo-molding, and even then never touching anything but hot or cold air until the metal is deposited. The metallized side is accordingly pristine as well as the side that contacted the mold, resulting in a beautiful finished mirror or other part. After metallization the part is typically back-coated to protect the metallization, and trimmed (FIG. 2b) to final outer dimensions.

Though the Figures depict an apparatus for making a single part, the vacuum box can be constructed to be large enough to define in the mold block several molding cavities, for the simultaneous fabrication of multiple parts, for example, convex mirrors, in groups of 4, 6, 8, 10, etc. If desired, separate mold blocks can be provided in the vacuum box for creating each mold cavity, to attain reduced costs, easier servicing, repair and/or for better individualized control and regulation of the fabrication of each part in the same vacuum box. Multi-cavity molds have higher capital cost, but reduce labor content and thus reduce unit costs in mass-production applications.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed:

1. A process for forming a non-planar mirror element of a predefined three dimensional shape from a plastic sheet, the method comprising the steps of:
providing a block of microporous material having the selected three dimensional shape formed on one surface in a cavity of said block;
placing a plastic sheet over the block, in a position which enables the plastic sheet to be drawn into the cavity;
heating the plastic sheet and applying a vacuum through the microporous material to draw the heated plastic sheet to conform to the three-dimensional shape in the block; and
metallizing a surface of the conformed plastic sheet to a form an optical mirror surface.

2. The process of claim 1, wherein the plastic sheet is planar and of a uniform thickness.

3. The process of claim 1, wherein the plastic sheet comprises optical quality material selected from acrylic, polycarbonate and PETG.

4. The process of claim 3, wherein the material is acrylic and at least the surface which contacts the block is covered with removable poly masking.

5. The process of claim 1, wherein the plastic sheet is heated only on a side of the plastic sheet facing away from the block whereby a side of the plastic sheet facing the block is sufficiently heated to enable the plastic sheet to be drawn to the shape in the block but with insufficient heat to create significant tooling mark-offs with removal of the plastic from the block.

6. The process of claim 1, wherein the plastic sheet is heated prior to applying the vacuum and wherein after the start of the applying of the vacuum, heating is stopped and a side of the plastic sheet facing away from the block is sufficiently cooled to maintain uniform cooling of both sides of the plastic sheet.

7. The process of claim 6, including applying the vacuum to the block while the plastic sheet is cooling.

8. The process of claim 1, including metallizing the side of the plastic sheet opposite the surface which contacts the block.

9. The process of claim 1, wherein the plastic sheet is heated with an infra red heater.

10. A process for forming a mold capable of forming a non-planar element from a plastic sheet, the process comprising the steps of:
selecting a predefined three dimensional shape to be formed;
machining a block of microporous material to form the mold and to provide the selected three dimensional shape therein, which shape is accessible through an opening in the block;
locating the block in a housing, such that the block opening remains accessible; and
providing a vacuum generator which is structured to apply a vacuum to the block, on a side thereof away from said three-dimensional shape.

11. The process of claim 10, wherein the block comprises pores having an average diameter smaller than 0.02 mm.

12. The process of claim 10, including heating a plastic sheet and applying a vacuum through the microporous material to draw the heated plastic sheet to conform to the shape in the block.

13. The process of claim 12, including maintaining the temperature of the mold between 120° F. and 200° F. during the conforming of the plastic sheet to the shape in the block.

14. The process of claim 10, further comprising forming the block by polishing the surface of the three dimensional shape prior to placing the plastic sheet over the block.

15. The process of claim 14, including polishing said block by successively using at least two abrasive materials of progressively finer grits or finer abrasive non-wovens.

16. The process of claim 10, further comprising providing the block with an element for uniform temperature control.

17. The process of claim 16, wherein the element for uniform temperature control comprises water tubing.

18. The process of claim 10, wherein the block material is aluminum.

19. The process of claim 10, wherein the block is machined with at least two three dimensional shapes of the same or different shapes for simultaneously forming at least two non-planar elements.

20. The process of claim 10, wherein the block is machined by entering the selected shape into CAD/CAM software and using the software to drive a machining tool to machine the block.

21. The process of claim 1, including maintaining the temperature of the block between 120° F. and 200° F. during the conforming of the plastic sheet to the shape in the block.

22. An optically accurate non-planar element made by the process of claim 1.
